(19) United States
(12) Patent Application Publication
(10) Pub. No.: US 2011/0215774 A1
(43) Pub. Date: Sep. 8, 2011

(54) AC POWER CONTROL WITH INTEGRAL POWER FACTOR CORRECTION

(75) Inventors: Donald G. Colvin, Mukilteo, WA (US); Harold G. Middleton, Seattle, WA (US)

(73) Assignee: ELECTRONIC ENERGY SOLUTIONS LLC, Kintnersville, PA (US)

(21) Appl. No.: 13/033,365

(22) Filed: Feb. 23, 2011

Related U.S. Application Data
(60) Provisional application No. 61/310,652, filed on Mar. 4, 2010.

(51) Int. Cl. G05F 1/70

(52) U.S. Cl. 323/205

(57) ABSTRACT

Device and method for high efficiency (low heat loss) control of AC power to reactive load while maintaining a high power factor.

### CROSS REFERENCE TO RELATED APPLICATIONS

This application claims priority to U.S. Provisional Patent Application No. 61/310,652 to Colvin et al., entitled “AC Power Control with Integral Power Factor Correction”, filed Mar. 4, 2010, the entirety of which is hereby incorporated by reference herein.

### FIELD OF THE INVENTION

The present invention relates to the high efficiency (low heat loss) control of AC power to a reactive load while maintaining a high power factor.

### BACKGROUND OF THE INVENTION

Loads powered by the AC power grid become inefficient when the load current is partly comprised of reactive components. Phase shift between the applied voltage and the load current, and current harmonics, result in the load consuming more current from the grid than is converted to energy by the load. This inefficiency is quantified by the Power Factor (PF). The PF is the mathematical relationship between the apparent power in VA and the actual power consumed by the load and is measured in Watts.

This relationship is described as: PF=Watts/VA.

For example, a high intensity discharge (HID) lamp with a magnetic ballast will have a lagging current relative to the applied voltage. Further, an HID lamp load will result in what are known as current harmonics. This occurs when the current waveform is not a pure sine wave but has harmonic components. The harmonic components of the current waveform are typically caused by a non-linear load. This is a load that draws a disproportionate amount of current at some points during the course of one AC power cycle. These harmonic components in the current waveform will also degrade the PF.

It is common that a reactive load using an AC supply voltage will have added components electrically sized and connected to compensate for the reactive component of the load. These components may be sized to substantially correct for the phase shift and may even correct for some amount of the current harmonics when the load is at full power. For example, what is commonly called the PF capacitor on an HID lamp ballast is electrically sized and placed to counteract the inductive effects the magnetic ballast has on the load current.

One common method to control the power delivered to an electrical load is by interrupting or modulating the current passing to the load. When the interruptions are done at high frequency the average power applied to the load is smoothed and appears to be smoothly reduced. For example U.S. Pat. No. 5,500,575, the entirety of which is hereby incorporated by reference herein, teaches controlling the power to a load using PWM (pulse width modulation).

The difficulty arises when an attempt is made to lower the power level consumed by the load. This change in power level will change the electrical value of the components needed to properly compensate for the reactive and non-linear load. Now the original electrical size of the fixed components will no longer produce the desired PF.

One object of the present invention is to dynamically correct the current waveform to maintain a high PF value for any value of load power desired. This is done electronically in this invention without the need to alter the electrical value of any compensation components.

### BRIEF SUMMARY OF THE INVENTION

The present invention is a method for controlling the level of power delivered from the AC power grid to a reactive AC load while maintaining a high PF. This is accomplished by first controlling the power to the load by the PWM of a series pass element. Further the duty cycle of this PWM is modulated to a controlled percentage by a second order modulation which allows control such that the duty cycle may be varied hundreds or thousands of times during each AC power cycle. This process allows the waveform of the current delivered to the load to be sculpted from a reactive and harmonic rich waveform to a waveform more similar to a pure sine wave.

### BRIEF DESCRIPTION OF THE DRAWINGS

For the purpose of illustrating the invention there is shown in the drawings a form that is presently preferred; it being understood, however, that this invention is not limited to the precise circuits and connections shown nor even limited to the alternates shown.

FIG. 1 is a simplified schematic as an overall view of one example of the present invention.

FIG. 2(a) is a simplified schematic of a first implementation of a series pass element.

FIG. 2(b) is a simplified schematic of a second implementation of a series pass element

### DETAILED DESCRIPTION OF THE INVENTION

### Overview of Functional Description of the Invention

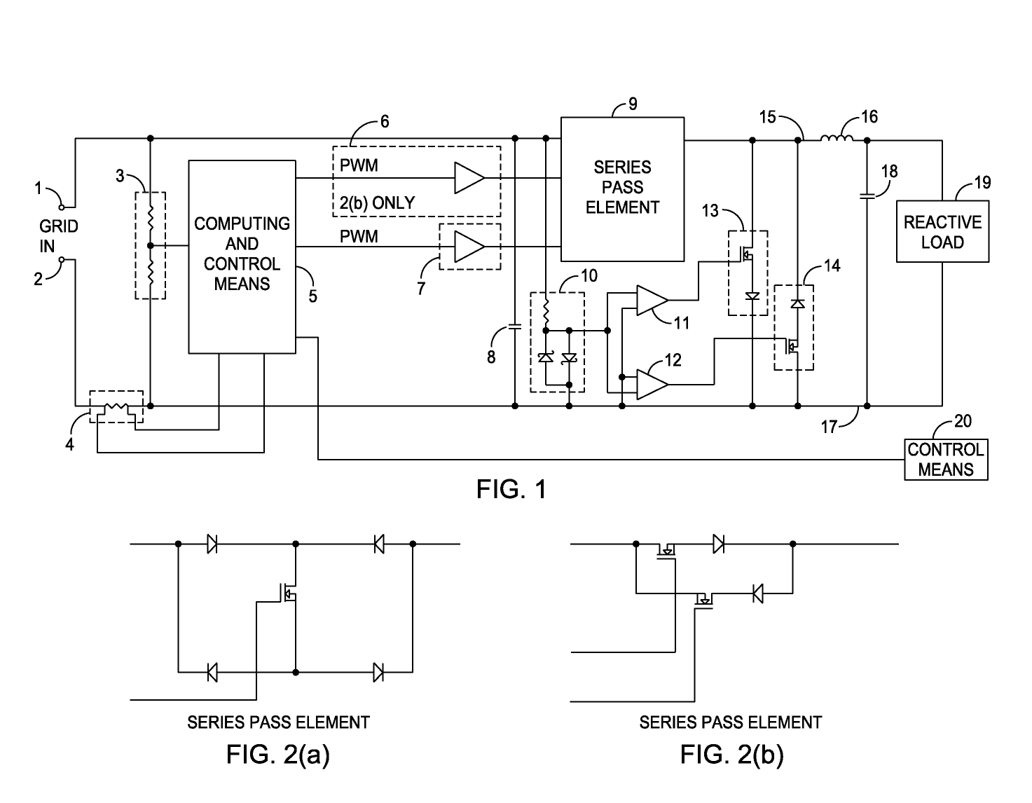

There is shown in FIG. 1 one example of the implementation of the present invention. The description of the operation from FIG. 1 follows:

During each AC voltage cycle while the series pass element 9 is enabled to pass current, the current from the grid flows through terminal 1, through series pass element 9, through inductor 16, through load 19, through line 17, through current sense circuit 4 and finally back to the grid on terminal 2.

Also during each AC voltage cycle the instantaneous voltage sample output of the voltage sense circuit 3 is continuously input to the computing and control means 5 (or simply “computing means”) and the instantaneous current sample output of the current sense circuit 4 is continuously input to the computing means 5.

When the series pass element 9 is disabled (blocking the current flow) there is no flow of current from the power grid to the load. However, immediately after the series pass element 9 is disabled the field built up in inductor 16 collapses which creates a voltage source across inductor 16 which is between load 19 and line 15. This voltage source will be negative at line 15 during the portion of the cycle when the input at terminal 1 is positive relative to terminal 2 and conversely the voltage source developed across inductor 16 will be positive at line 15 when the input at terminal 1 is negative relative to terminal 2.

When the polarity of the voltage at terminal 1 is negative relative to terminal 2 then clamp circuit 13 will be enabled by zero crossing detector 10. When the collapsing field in inductor 16 creates a voltage source then the collapsing field in inductor 16 will cause current to flow through load 19, through line 17, through clamp circuit 13, through line 15 and back to inductor 16.

When the polarity of the voltage at terminal 1 is positive relative to terminal 2 then clamp circuit 14 will be enabled by zero crossing detector 10. When the collapsing field in inductor 16 creates a voltage source then the collapsing field in inductor 16 will cause current to flow through load 19, through line 17, through clamp circuit 14, through line 15 and back to inductor 16.

This current flow with the series pass element 9 disabled represents a gain in efficiency by accomplishing productive work with power that would be otherwise unproductive.

Particular attention is focused on the clamp circuits 13 and 14. The use of a series diode and a switch has a specific benefit. While the intrinsic diodes in a FET transistor may be used as the clamp diodes, in such a circuit these intrinsic diodes by their nature waste a lot of power. A low forward voltage rated diode is much more efficient, wasting less power in heat loss. This becomes more important as the power level in the load increases.

The above description of the operation of the circuit serves as a basis for the following discussion concerning the power factor correction accomplished by the present invention.

The waveform of the current flowing into a circuit as described above will not be a pure sine wave. Without some form of PF correction the current waveform will be phase shifted from the voltage waveform and will contain harmonics due to the discontinuous flow of current.

The present invention controls this current waveform by adjusting the current flow from the grid dynamically during the voltage waveform sine wave. The decreased current flow during the lower voltage portions of the voltage waveform is compensated for by increasing the current flow during the higher voltage portions of the voltage waveform. This sculpting of the current waveform creates a current waveform that is much more like a pure sine wave and therefore decreases the VA requirement for a given power level of Watts delivered to the load.

### Circuit Block Detailed Description of the Invention

The AC input line power is applied across terminals 1 and 2, with terminal 1 being referred to as the HOT and terminal 2 being referred to as the neutral.

The voltage sense circuit 3 is comprised of a resistor divider placed across the line power to reduce the applied voltage to a level suitable to be fed to an analog to digital converter (ADC) input included within the computing means 5. The ADC in the present embodiment is contained within a microprocessor of the computing means 5.

The current sense circuit 4 is comprised of a Kelvin connected sense resistor such that the AC voltage developed across the resistor is representative of the input line power AC current flow. The output of the current sense circuit is fed to an input of the computing means 5.

The computing means 5 may be any form of computing means suitable for this application. In the preferred embodiment a SiLabs C8051F330 sold by Silicon Laboratories Inc., 400 W. Cesar Chavez, Austin, Tex. was used and common differentially connected op-amps were used to scale the inputs from the voltage sense circuit 3 and the current sense circuit 4 to proper levels for the SiLabs processor's internal ADC.

The isolator amplifier 7 (and the isolator amplifier 6 if present) receives the output signal from the computing means 5 and drives the series pass element 9. The isolator amplifier 7 is (and the isolator amplifier 6 is if present) comprised of a Si8440 RF isolator chip sold by Silicon Laboratories Inc. in this embodiment. Alternatively, other means of isolation may be employed.

Capacitor 8 prevents the high frequency electrical noise created from the switching of series pass element 9 from propagating back onto the AC input power lines.

Series pass element 9 has at least two possible implementations as shown in FIG. 2(a) and FIG. 2(b). The method shown in FIG. 2(a) allows for a simplified drive scheme while the method shown in FIG. 2(b) has less overhead power loss (waste) while requiring a second isolated drive circuit and a more complex drive algorithm in the computing means 5.

The zero crossing detector 10 is used to steer the catch diodes of the clamp circuits 13 and 14 through comparator and isolation circuits 11 and 12. The comparator function of the comparator and isolation circuits 11 and 12 is accomplished by a common comparator IC, and the isolation function is accomplished by providing an optical coupler (not shown) to isolate the FET gate of each of the clamp circuits 13 and 14 from the zero crossing detector 10. Alternatively, other means of isolation may be employed.

The zero crossing detector 10 is used to steer the catch diodes of the clamp circuits 13 and 14 based on the voltage polarity of the AC cycle. Both clamp diodes of the clamp circuits 13 and 14 are never on at the same time. If terminal 1 of the input line power is negative with respect to terminal 2 then the catch diode of the clamp circuit 13 is turned on. If terminal 1 of the input line power is positive with respect to terminal 2 then the catch diode of the clamp circuit 14 is turned on.

Catch diodes of the clamp circuits 13 and 14 are selected with only one active at any given time as mentioned above, and serve to catch the counter EMF induced in inductor 16 by the collapsing field that occurs when the series pass element 9 is turned off.

Capacitor 18 serves to filter the high frequency inductor currents resulting from the PWM switching leaving only the low frequency sine wave to be applied to the reactive load.

Control input means 20 may be a digital or analog signal, such as a 0-10V analog voltage, representing the level of power reduction being requested. This signal is read by the computing means 5 as an input to the computing means. This request comes from a source outside the invention that determines the required power level.

The present embodiment is constructed on a Printed Circuit Board (PCB) and it is apparent to those skilled in the art that the details of circuit layout should be given adequate attention considering the inductance of PCB traces and the sharp voltage and current wave fronts created by the switching of the series pass element 9.

### Description of the Operation of the Computing and Control Means

PF is commonly referred to in the electrical industry as either leading or lagging. A leading PF is capacitive and refers to the current leading the voltage. A lagging PF is inductive and refers to the current lagging the voltage. While PF in many instances will be expressed as an absolute value (no arithmetic sign) it is often instructive to use a signed number to represent any PF value less than 1. When the PF value is 1 the current waveform is perfectly following the voltage waveform, there is no VAR, therefore there is no leading or lagging current, and Watts is equal to VA. For any PF value less than 1 the PF value is either negative for leading (capacitive) reactance or the PF value is positive for lagging (inductive) reactance. The sum of the instantaneous value of the PF is determined by the larger of the two reactance values, capacitive or inductive.

For the purpose of modulating the AC line current to compensate for PF values less than perfect (less than 1) the present invention uses a reference sine wave as part of the correction scheme. This reference sine wave is internally generated within the computing means 5. This internally generated reference sine wave is phase locked, with a variable amount of phase shift, to the AC line voltage cycle by the computing means 5. The variable amount of phase shift is set by the value of the signed phase shift factor variable adjusted by the computing means 5 as further described below.

The computing means 5 is responsible for accomplishing the following Actions:
1) Periodically capture the instantaneous voltage and current readings received from the voltage sense circuit 3 and the current sense circuit 4.
2) Compute the instantaneous power reading.
3) Compute the Vrms, Irms, Prms, and PF values.
4) Adjust the phase shift factor based on the computed arithmetic sign of the PF.
5) Compute the PWM base duty cycle based on the requested power reduction.
6) For each PWM cycle, modulate the PWM base duty cycle based on the internally computed reference sine wave value as phase shifted by the last AC voltage cycle PF computation.

Action 1, periodically capture the instantaneous voltage and current readings. This is accomplished in the standard fashion known to those skilled in the art. That is, these readings are taken and stored periodically using the ADC within the computing means 5. In the present embodiment these readings are taken each 100 microseconds but it would be known to those skilled in the art that readings can be taken more or less often without changing the basic function as used in the present invention.

Action 2, compute the instantaneous power reading. This is accomplished by multiplying the instantaneous voltage by the instantaneous current each time those readings are taken and storing the result as the instantaneous power computation.

Action 3, compute the Vrms, Irms, Prms, and PF values. This is accomplished by formulae that are well known to a person of skill in the art. For example, one integrated circuit identified as CS5463 manufactured by Cirrus Logic, Inc., 2901 Via Fortuna, Austin, Tex. 78746 (www.cirrus.com) and other similar chips manufactured by Cirrus and other manufacturers document these formulae in great detail.

Action 4, adjust the phase shift factor based on the computed arithmetic sign of the PF. Determining the magnitude of the phase shift required between the incoming AC voltage and the computed sine wave value is determined at the end of each AC voltage cycle by examining the arithmetic sign of the computed PF value. If the sign of the PF value is positive, increment the phase shift factor, if the sign of the PF value is negative, decrement the phase shift factor. This results in a constant movement of the phase shift factor around the most perfect possible PF value.

Action 5, compute the PWM base duty cycle based on the requested power reduction. This is accomplished by first subtracting the requested power reduction from 100% to determine the desired power level. Then the 100% duty cycle value is multiplied by the fractional number representing the desired power level and the result is the required base duty cycle percentage for the PWM.

Action 6, for each PWM cycle, modulate the PWM base duty cycle based on the internally computed reference sine wave value as phase shifted by the last AC voltage cycle PF computation (Action 4). This modulation adjustment is done for each PWM pulse and is computed by adding the present instantaneous value of the internally computed reference sine wave to the base duty cycle percentage.

Although the present invention has been described with reference to the preferred embodiment thereof, it is apparent to those skilled in the art that a variety of modifications and changes may be made without departing from the scope of the present invention.

What is claimed is:

1. A power controller for a reactive alternating current (AC) load, comprising:
first and second input terminals for coupling to an AC power signal;
a voltage sense circuit for sensing a voltage level of the AC power signal;
a current sense circuit for sensing a current level of the AC power signal;
a series pass element coupled between the first input terminal and the reactive load for passing the AC power signal to the reactive load; and
computing and control means coupled to the series pass element, the computing and control means providing a pulse width modulated (PWM) control signal for the series pass element responsive to the voltage and current levels of the AC power signal and a power reduction level input signal, wherein the computing and control means varies a duty cycle of the PWM control signal during each AC power cycle of the AC power signal to maintain a high power factor.
